(19) United States
(12) Patent Application Publication
(10) Pub. No.: US 2023/0229456 A1
(43) Pub. Date: Jul. 20, 2023

(54) WAKING DEVICE AND METHOD FOR WAKING AN ELECTRONIC DEVICE

(71) Applicant: CHICONY ELECTRONICS CO., LTD., New Taipei City (TW)

(72) Inventors: Shang-Yuan YUAN, New Taipei City (TW); Tung-Hsin HUANG, New Taipei City (TW)

(21) Appl. No.: 17/863,811

(22) Filed: Jul. 13, 2022

(30) Foreign Application Priority Data
Jan. 6, 2022 (TW) 111100607

(51) Int. Cl. G06F 9/4401; G01S 13/04

(52) U.S. Cl. CPC G06F 9/4418; G01S 13/04

(57) ABSTRACT

A. waking device is used for waking an electronic device. The waking device includes an infrared sensor and a radar sensor. The infrared sensor continuously measures an energy value in a detection area. When the infrared sensor detects an energy variation, the infrared sensor sends a trigger signal. The radar sensor is electrically connected to the infrared sensor and the electronic device. After the radar sensor receives the trigger signal, the radar sensor switches from a sleep mode to an operating mode. Furthermore, when the radar sensor determines that there is a moving object in the detection area, the radar sensor sends a wake-up signal to the electronic device.

### BACKGROUND

### 1. Technical Field

The present disclosure relates to a waking device and a method for waking an electronic device.

### 2. Description of the Related Art

There are many electronic devices such as automatic doors, or monitoring devices equipped with a wake-up function. That is, the electronic device is generally in a dormant state (i.e., a sleep mode), and when it receives an activation signal or detects a moving object, it switches to a working state (i.e., an operating mode) to execute a corresponding function. For example, when a person or an animal passes by, an automatic door can open the door, and a monitoring device starts recording (working state). With the prevalence of smart home appliances, the wake-up function is applied to more types of electronic devices, such as smart lighting devices, electronic doorbells, etc. When a person or an animal passes by, the smart lighting device can turn on the light source, and the electronic doorbell can ring.

Generally speaking, an electronic device with a wake-up function uses a motion sensor to detect moving objects. A common motion sensor is a passive infrared sensor, which is suitable for electronic devices only working when there is a moving object due to its power-saving characteristics. However, the accuracy of passive infrared sensors can be affected by various interferences in the environment and the accuracy tends to be low when misjudgments happen frequently. Besides, when the electronic device is awakened and works under the condition of misjudgment, which also causes the problem of power consumption. Therefore, it is necessary to improve the disadvantage of the prior art.

### SUMMARY

In view of the above problems, a main object of the present disclosure is to provide a waking device and method used for waking up an electronic device. By using an infrared sensor and a radar sensor to detect conditions in a detection area, the present disclosure can solve the power consumption problem of conventional waking device and method.

To achieve the above object, the present disclosure provides a waking device for waking an electronic device. The waking device comprises an infrared sensor and a radar sensor. The infrared sensor continuously measures an energy value in a detection area. When the infrared sensor detects an energy variation, the infrared sensor sends a trigger signal. The radar sensor is electrically connected to the infrared sensor and the electronic device. After the radar sensor receives the trigger signal, the radar sensor switches from a sleep mode to an operating mode. Furthermore, when the radar sensor determines that there is a moving object in the detection area, the radar sensor sends a wake-up signal to the electronic device.

To achieve the above object, the present disclosure provides a waking method for waking an electronic device, which comprises an infrared sensor and a radar sensor. The waking method comprises the following steps of: the infrared sensor continuously measuring an energy value in a detection area; when the infrared sensor detects an energy variation, the infrared sensor sending a trigger signal; after the radar sensor receives the trigger signal, the radar sensor switching from a sleep mode to an operating mode; and when the radar sensor determines that there is a moving object in the detection area, the radar sensor sending a wake-up signal to the electronic device.

According to an embodiment of the present disclosure, the infrared sensor is a passive infrared sensor.

According to an embodiment of the present disclosure, the energy value comprises infrared radiation energy emitted or reflected by an object, and the energy variation is the difference between the energy value and a background value.

According to an embodiment of the present disclosure, the radar sensor comprises a microwave transmitting unit and a microwave receiving unit, the microwave transmitting unit transmits an emitted microwave to the detection area, and the microwave receiving unit receives a reflected microwave, when the frequency of the reflected microwave is different from that of the emitted microwave, the radar sensor sends the wake-up signal.

According to an embodiment of the present disclosure, when the frequency of the reflected microwave is the same as that of the emitted microwave, the radar sensor switches to the sleep mode.

As described above, the waking device and method of the present disclosure can wake an electronic device. The waking device comprises an infrared sensor and a radar sensor, and the radar sensor is electrically connected to the infrared sensor and the electronic device respectively. An energy value in the detection area is continuously measured by the power-saving infrared sensor. When the infrared sensor detects an energy change, it sends a trigger signal to the radar sensor to wake the radar sensor having higher sensitivity to determine again whether there is a moving object in the detection area. In other words, the waking device and method of the present disclosure use the power-saving infrared sensor to continuously detect the detection area, and then use the radar sensor having high-sensitivity to perform secondary confirmation, which can greatly reduce the possibility of misjudgment, and thus achieving energy saving effect.

### BRIEF DESCRIPTION OF THE DRAWINGS

FIG. 1 illustrates a block diagram of a waking device of an embodiment of the present disclosure; and

FIG. 2 is illustrates a flowchart showing the steps of a waking method of an embodiment of the present disclosure.

### DETAILED DESCRIPTION OF THE EMBODIMENTS

In order to make the structure, characteristics, and effectiveness of the present disclosure further understood and recognized, a detailed description of the present disclosure is provided as follows, along with embodiments and accompanying figures.

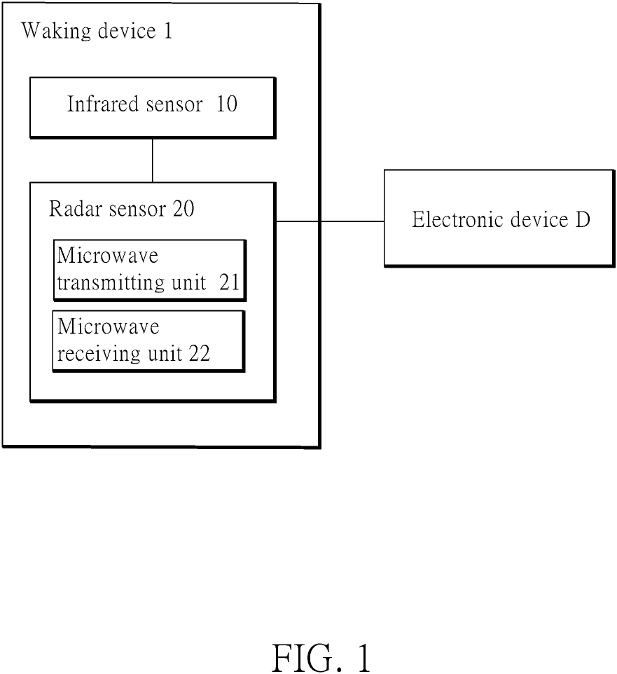

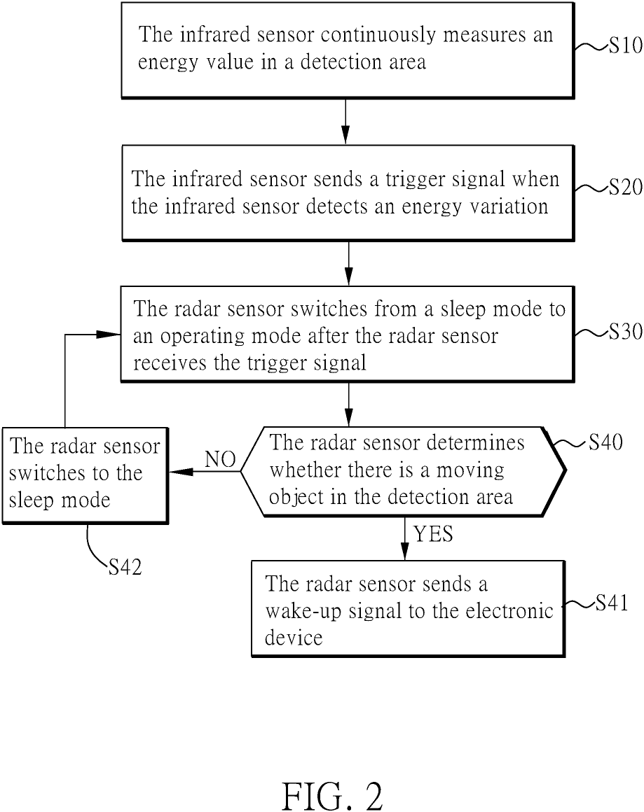

FIG. 1 illustrates a block diagram of a waking device of an embodiment of the present disclosure, and FIG. 2 illustrates a flowchart of a waking method of an embodiment of the present disclosure. Please refer to FIG. 1 and FIG. 2. A waking device 1 of this embodiment is used for waking an electronic device D, wherein the electronic device D can be, for example, but not limited to, an automatic door control device, a monitoring device, a smart lamp, or an electronic doorbell that does not need to continuously perform its function. In an embodiment, the waking device 1 can be assembled to the electronic device D so that the waking device 1 and the electronic device D can jointly form a single device. In an embodiment, the waking device 1 and the electronic device D can be disposed in different locations, and are electrically connected to each other through a wired or wireless means.

In this embodiment, the waking device 1 includes an infrared sensor 10 and a radar sensor 20, and the infrared sensor 10 is electrically connected to the radar sensor 20. Furthermore, the radar sensor 20 is electrically connected to the electronic device D. The waking method of this embodiment can be performed by the infrared sensor 10 and the radar sensor 20 of the waking device 1. The structures and functions of the infrared sensor 10 and the radar sensor will be further described in detail in conjunction with the following steps of the waking method.

Step S10: the infrared sensor 10 continuously measures an energy value in a detection area.

The infrared sensor 10 of this embodiment is a passive infrared sensor (passive infrared sensing module), which can receive or measure the radiated or reflected infrared radiation energy of objects in the environment (referring to detection area in this embodiment). The energy value in this embodiment is the infrared radiation energy emitted or reflected by the object. Preferably, the infrared sensor 10 may have a filter that transmits radiation in a specific wavelength range, so as to detect the presence or movement of a human body or other animal body.

Specifically, warm-blooded animals emit radiation. For example, the human body generally emits radiation with a wavelength peak of about 9 micrometers (µm) to 10 micrometers (µm), which is in the infrared wavelength range (between 0.75 and 1,000 micrometers). Preferably, the infrared sensor 10 can be provided with a filter to block the infrared light of most wavelengths, and to limit the wavelength peak of the incident light to a range of 7 micrometers to 10 micrometers, so that the infrared sensor 10 is suitable for detecting human bodies.

Step S20: the infrared sensor 10 sends a trigger signal when the infrared sensor detects an energy variation.

In this embodiment, the infrared sensor 10 is used as an uninterrupted component to continuously measure the energy value in the detection area (i.e., the infrared radiation energy) due to its power saving feature. In addition, the infrared sensor 10 is preset with a background value, and the infrared sensor 10 compares the measured energy value with the background value. When a person or other warm-blooded animals pass by in the detection area, the infrared sensor 10 can detect the infrared radiation energy emitted or reflected by the human body or other warm-blooded animal bodies. The energy value measured by the infrared sensor 10 at this time is different from the preset background value, which is called energy variation in this embodiment. In other words, the energy variation can be the difference between the energy value and the background value. When the infrared sensor 10 detects the energy variation, it can convert the energy variation into a current signal (called a trigger signal in this embodiment) and output the current signal. That is, when the infrared sensor 10 detects the energy variation, it can send a trigger signal.

Preferably, the infrared sensor 10 can also set a trigger threshold. That is, only when the difference between the energy value and the background value (i.e., the energy variation) is greater than the trigger threshold, the infrared sensor 10 sends a trigger signal. In this embodiment, the infrared sensor 10 sends the trigger signal to the radar sensor 20, and the radar sensor 20 determines the environmental conditions in the detection area again.

Step S30: the radar sensor 20 switches from a sleep mode to an operating mode after the radar sensor receives the trigger signal.

The radar sensor 20 has high sensitivity and can accurately determine whether there is a moving object in the detection area, but it consumes more power. Therefore, the radar sensor 20 of the present embodiment is usually in a sleep mode, and only switches to an operating mode after receiving a trigger signal from the infrared sensor 10. The radar sensor 20 can determine whether there is a moving object (such as a person or other animals) in the detection area in the operating mode. That is, the waking method goes to step S40.

Step S40: the radar sensor 20 determines whether there is a moving object in the detection area.

The radar sensor 20 uses the principle of the Doppler effect to detect moving objects in the detection area. Specifically, the radar sensor 20 of this embodiment includes a microwave transmitting unit 21 and a microwave receiving unit 22. The microwave transmitting unit 21 transmits an emitted microwave to the detection area to form a microwave electromagnetic field in the detection area. The microwave receiving unit 22 is configured to receive a reflected microwave in the detection area. The reflected microwave is the echo reflected by the object in the detected area. When the object in the detection area is stationary, the frequency of the reflected microwave will be the same as that of the emitted microwave. On the contrary, when there is a moving object in the detection area, the wavelength and frequency of the reflected microwave will change, that is, different from the wavelength and frequency of the emitted microwave.

In other words, when the frequency of the reflected microwave received by the microwave receiving unit 22 is different from that of the emitted microwave, it means that there is a moving object in the detection area, and the radar sensor 20 can send a wake-up signal to the electronic device D, as described in step S41. On the contrary, when the frequency of the reflected microwave received by the microwave receiving unit 22 is the same as the frequency of the emitted microwave, it means that there is no moving object in the detection area, and the radar sensor 20 can switch to the sleep mode again, as described in step S42.

Step S41: the radar sensor 20 sends a wake-up signal to the electronic device D.

When the microwave receiving unit 22 of the radar sensor 20 detects a change in the frequency of the reflected microwave, that is, the frequency of the reflected microwave is different from that of the emitted microwave, the frequency variation can be converted into a current signal (i.e., a wake-up signal) for output. In other words, the radar sensor 20 sends a wake-up signal to the electronic device D.

After the electronic device D receives the wake-up signal, it can also switch from a sleep mode to an operating mode, or directly perform the corresponding action. For example, when the electronic device D is a monitoring device, after receiving the wake-up signal, the electronic device D can switch from its sleep mode to its operating mode, and start recording video with respect to the detection space. Furthermore, when the electronic device D is an automatic door, the electronic device D can open the door after receiving the wake-up signal. When the electronic device D is a lighting device, the electronic device D can turn on the light after receiving the wake-up signal. When the electronic device D is an electronic doorbell, the electronic device D can ring after receiving the wake-up signal.

In this embodiment, the energy-saving infrared sensor 10 is used for continuously detecting the detection area. When the infrared sensor 10 determines that there may be a person or a warm-blooded animal in the detection area, then the radar sensor 20 having higher sensitivity is used for determining whether there is really a moving object in the detection area. In other words, after the infrared sensor 10 and the radar sensor 20 both determine that there is a moving object in the detection area, then the electronic device D is awakened, thereby achieving the power saving effect. Specifically, the prior art technique only uses the infrared sensor as the motion sensor, so when the electronic device is awakened due to the misjudgment of the infrared sensor, it could increase power consumption. The waking device 1 of the present embodiment needs to pass the confirmation of the infrared sensor 10 and the secondary confirmation of the radar sensor 20; by doing so, the waking device 1 can greatly reduce the possibility of misjudgment, and thus achieving energy saving effect.

Step S42: the radar sensor 20 switches to the sleep mode.

On the contrary, when the reflected microwave received by the microwave receiving unit 22 of the radar sensor 20 has the same frequency as that of the emitted microwave, it means that the radar sensor 20 determines that there is no moving object in the detection area. At this time, the radar sensor 20 can switch to the sleep mode again. Next, the method returns to step S30, after receiving the trigger signal from the infrared sensor 10, the radar sensor 20 switches to the operating mode to determine whether there is a moving object in the detection area.

As described above, the waking device and method of the present disclosure can wake an electronic device. The waking device comprises an infrared sensor and a radar sensor, and the radar sensor is electrically connected to the infrared sensor and the electronic device respectively. An energy value in the detection area is continuously measured by the power-saving infrared sensor. When the infrared sensor detects an energy change, it sends a trigger signal to the radar sensor to wake the radar sensor having higher sensitivity to determine whether there is a moving object in the detection area. In other words, the waking device and method of the present disclosure use the power-saving infrared sensor to continuously detect the detection area, and then use the radar sensor having high-sensitivity to perform secondary confirmation, which can greatly reduce the possibility of misjudgment, and thus achieving energy saving effect.

It is noted that the above-described embodiments are merely illustrative of preferred embodiments of the present disclosure, and that in order to prevent redundancy, not all possible combinations of the variations are described in detail; various changes and modifications may be made to the described embodiments without departing from the scope of the disclosure as described by the appended claims.

What is claimed is:

1. A waking device for waking an electronic device, the waking device comprising:
an infrared sensor configured to continuously measure an energy value in a detection area, wherein the infrared sensor sends a trigger signal when the infrared sensor detects an energy variation; and
a radar sensor being electrically connected to the infrared sensor and the electronic device, and the radar sensor is configure to switch from a sleep mode to an operating mode after the radar sensor receives the trigger signal, and wherein when the radar sensor determines that there is a moving object in the detection area, the radar sensor sending a wake-up signal to the electronic device.

2. The waking device as claimed in claim 1, wherein the infrared sensor is a passive infrared sensor.

3. The waking device as claimed in claim 1, wherein the energy value comprises infrared radiation energy emitted or reflected by an object, and the energy variation is the difference between the energy value and a background value.

4. The waking device as claimed in claim 1, wherein the radar sensor comprises a microwave transmitting unit and a microwave receiving unit, the microwave transmitting unit transmits an emitted microwave to the detection area, and the microwave receiving unit receives a reflected microwave, when the frequency of the reflected microwave is different from that of the emitted microwave, the radar sensor sends the wake-up signal.

5. The waking device as claimed in claim 4, wherein when the frequency of the reflected microwave is the same as that of the emitted microwave, the radar sensor switches to the sleep mode.

6. A waking method for waking an electronic device, wherein the waking method is applied to a waking device comprising an infrared sensor and a radar sensor, the method comprising the following steps of:
the infrared sensor continuously measuring an energy value in a detection area;
the infrared sensor sending a trigger signal when the infrared sensor detects an energy variation;
the radar sensor switching from a sleep mode to an operating mode after the radar sensor receives the trigger signal; and
when the radar sensor determines that there is a moving object in the detection area, the radar sensor sending a wake-up signal to the electronic device.

7. The waking method as claimed in claim 6, wherein the infrared sensor is a passive infrared sensor.

8. The waking method as claimed in claim 6, wherein the energy value comprises infrared radiation energy emitted or reflected by an object, and the energy variation is the difference between the energy value and a background value.

9. The waking method as claimed in claim 6, wherein the radar sensor comprises a microwave transmitting unit and a microwave receiving unit, the microwave transmitting unit transmits an emitted microwave to the detection area, and the microwave receiving unit receives a reflected microwave, when the frequency of the reflected microwave is different from that of the emitted microwave, the radar sensor sends the wake-up signal.

10. The waking method as claimed in claim 9 wherein when the frequency of the reflected microwave is the same as that of the emitted microwave, the radar sensor switches to the sleep mode.
